(19) United States
(12) Patent Application Publication
(10) Pub. No.: US 2017/0153936 A1
(43) Pub. Date: Jun. 1, 2017

(54) ROOT-CAUSE IDENTIFICATION SYSTEM AND METHOD FOR IDENTIFYING ROOT-CAUSE OF ISSUES OF SOFTWARE APPLICATIONS

(71) Applicant: Wipro Limited, Bangalore (IN)

(72) Inventor: Surya Vorganti, Bangalore (IN)

(73) Assignee: Wipro Limited

(21) Appl. No.: 14/996,273

(22) Filed: Jan. 15, 2016

(30) Foreign Application Priority Data
Nov. 27, 2015 (IN) 6380/CHE/2015

(51) Int. Cl. G06F 11/07

(52) U.S. Cl. CPC G06F 11/079; G06F 11/0706; G06F 11/0751; G06F 11/0778

(57) ABSTRACT

The present disclosure relates to a method for identifying root-cause of issues of software applications. The method comprises receiving one or more log files associated to software applications. The one or more log files are filtered to determine pattern of each log file of the one or more log files. One or more types of issues associated with each of the one or more log flies are determined based on the pattern of corresponding one or more log files. Trend of the one or more types of issues are estimated by comparing the one or more types of issues with historical data relating to corresponding pattern of log file. The root-cause of issues of the one or more software applications is identified based on at least one of the one or more types of issues and the trend of the one or more type of issues.

The following specification particularly describes the nature of the invention and the manner in which it is to be performed.

### FIELD OF THE DISCLOSURE

The present subject matter is related, in general to data processing system, and more particularly, but not exclusively to a root-cause identification system and a method for identifying root-cause of issues of software applications.

### BACKGROUND

Generally, various issues for example, without limitation, errors or logs or faults or mistakes occur in one or more software applications and hardware components during software productions. The issues relating to software production may be related to, without limitations, restarting of server unknowingly, degradation of server performance, high memory utilization, more stress on a particular single server, etc. However, presently, such issues are often difficult to trace and also a root cause of the corresponding issue. In one scenario; an operator or a service engineer manually needs to determine the originating root cause error and treat the issue.

Currently, all issues emerging during software production are analyzed manually by either the operator or the service engineer. More particularly, the operator or the service engineer needs to manually check the root-cause of the issue related to non-working of the server, replace the server or correct the functioning of the server after checking non-working or non-functioning conditions of the servers. Such a way of correcting the issue requires human intervention where the root-cause of the issue is found by manual checking. Further, presently, the operator or the service engineer experiences difficulty to distinguish which is the root cause of issues of software application or the hardware component. The operator or the service engineer often needs to guess/estimate the root cause of the issue based on other information such as error timing, experience, complex log files, etc. Such guesswork can be time-consuming and is often detrimental to the reliability of the hardware/software system. As such a technique for identifying root cause is not automated presently, the software production is delayed and in-situ solution to correct the issue in real-time is not possible.

In one conventional method, automated approach is carried out for analyzing the root-cause of the issue. In the conventional method, root-cause of the issue is analyzed depending on issues which have occurred previously. However, problem exists in such a way of approach for analysis of the root-cause of the issue since one or more issues may behave or would have same pattern. In such a case, there exists a problem in identifying which issue is related to which module of the software production. Hence, in the conventional method, an error or mistake may be committed in identifying the root-cause of the issue.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

In one embodiment, the present disclosure relates to a method for identifying root-cause of issues of software applications. The method comprises receiving one or more log files associated to one or more software applications from one or more sources. The method further comprises filtering the one or more log files to determine pattern of each log file of the one or more log files. The method further comprises determining one or more types of issues associated with each of the one or more log files based on the pattern of corresponding one or more log, files. The method further comprises estimating trend of the one or more types of issues by comparing the one or more types of issues with historical data relating to corresponding pattern of log file. The method further comprises identifying root-cause of issues of the one or more software applications based on at least one of the one or more types of issues and the trend of the one or more type of issues.

In another embodiment, the present disclosure relates to a root-cause identification system for root-cause of issues of software applications. The root-cause identification system further comprises a processor and a memory communicatively coupled to the processor, wherein the memory stores processor-executable instructions, which, on execution, cause the processor to perform operations to receive one or more log files associated to one or more software applications from one or more sources. The processor is further configured to filter the one or more log files to determine pattern of each log file of the one or more log files. The processor is further configured to determine one or more types of issues associated with each of the one or more log files based on the pattern of corresponding one or more log files. The processor is further configured to estimate trend of the one or more types of issues by comparing the one or more types of issues with historical data relating to corresponding pattern of log file. The processor is further configured to identify root-cause of issues of the one or more software applications based on at least one of the one or more types of issues and the trend of the one or more type of issues.

In another embodiment, the present disclosure relates to a non-transitory computer readable medium including instructions stored thereon that when processed by at least one processor causes a root-cause identification system for identifying root-cause of issues of software applications to perform the act of receiving one or more log files associated to one or more software applications from one or more sources. The medium further comprises act of filtering the one or more log files to determine pattern of each log file of the one or more log files. The medium further comprises act of determining one or more types of issues associated with each of the one or more log files based on the pattern of corresponding one or more log files. The medium further comprises act of estimating trend of the one or more types of issues by comparing the one or more types of issues with historical data relating to corresponding pattern of log file. The medium further comprises act of identifying root-cause of issues of the one or more software applications based on at least one of the one or more types of issues and the trend of the one or more type of issues.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates an exemplary embodiment of environment for identifying root-cause of issues of software application in software productions in accordance with sonic embodiments of the present disclosure;

FIG. 1b-1f shows examples of various log files in accordance with some embodiments of the present disclosure;

FIG. 2 illustrates a block diagram of the exemplary root-cause identification system with various data and modules for identifying root-cause of issues of software application in software productions in accordance with some embodiments of the present disclosure;

FIG. 3 shows a flowchart illustrating a method for identifying root-cause of issues of software application in software productions in accordance with some embodiments of the present disclosure; and

FIG. 4 is a block diagram of an exemplary computer system for implementing embodiments consistent with the present disclosure.

It should he appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to he construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a root-cause identification system for identifying root-cause of issues of software applications corresponding to a software production environment. Particularly, the present disclosure provides automated approach for identifying the root-cause of issues of software applications overcoming manual intervention by an operator or service engineer to identify the root-cause of the issue. In other words, human intervention is eliminated to identify the root-cause of the issue in the present disclosure. Further, the automated approach would identify the root-cause of the issue of the software applications by collecting all log files which are errors in software applications corresponding to the software production environment. Then, the automated approach filters the log files to determine patterns of the collected log files.

The patterns of the collected log files includes, without limitations, type of each log file, behavior of each log file, and alerts associated with each log file. Next, types of issues related to the filtered log files are determined. Trends of each type of issues are estimated for a predetermined time interval by comparing each type of issues with historical pattern related to the type of issues of log file resulted in past. Based on the type of issues and trends of each type of issues, root-cause of issues of the software applications is identified. In an embodiment, corrective measures towards each type of issues are recommended based upon identification of the root-cause of the corresponding type of issues.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

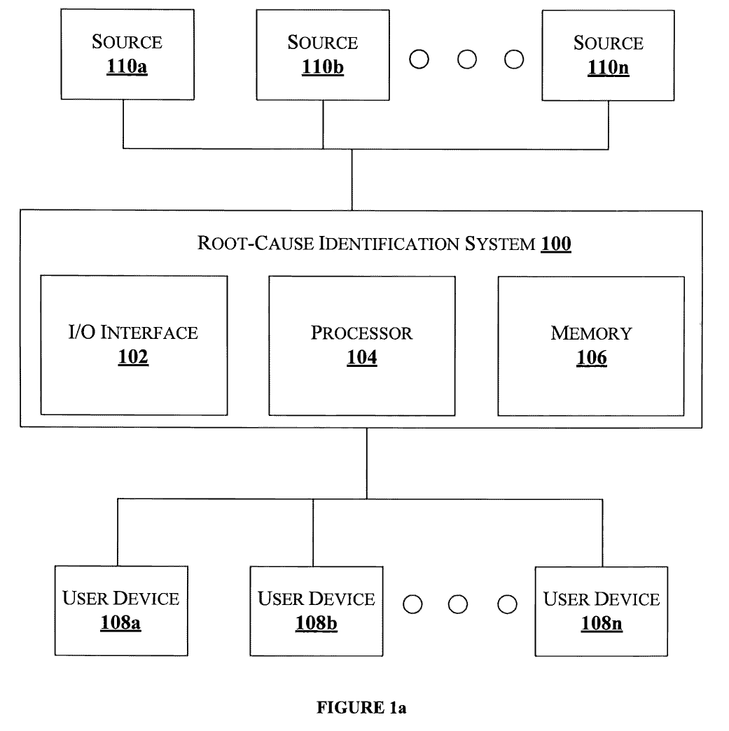

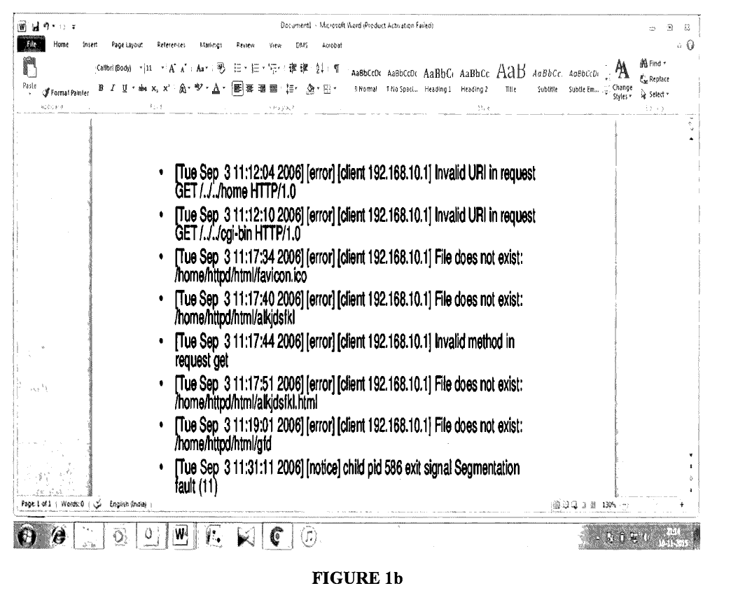

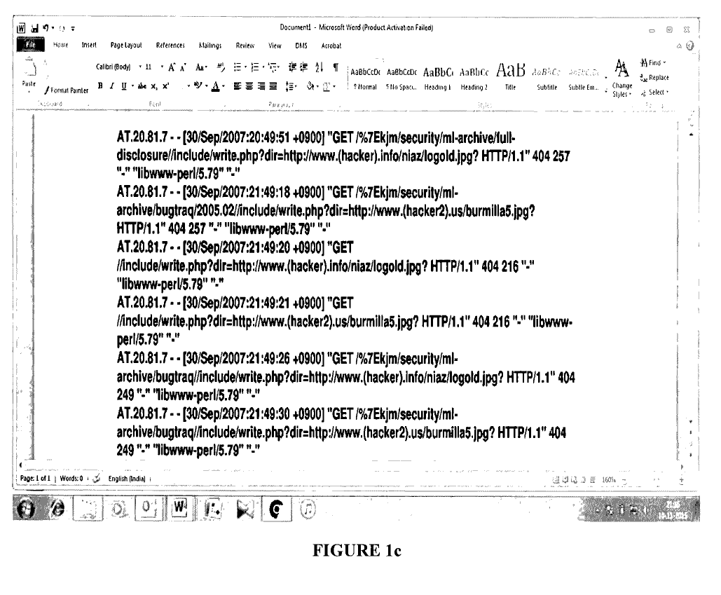

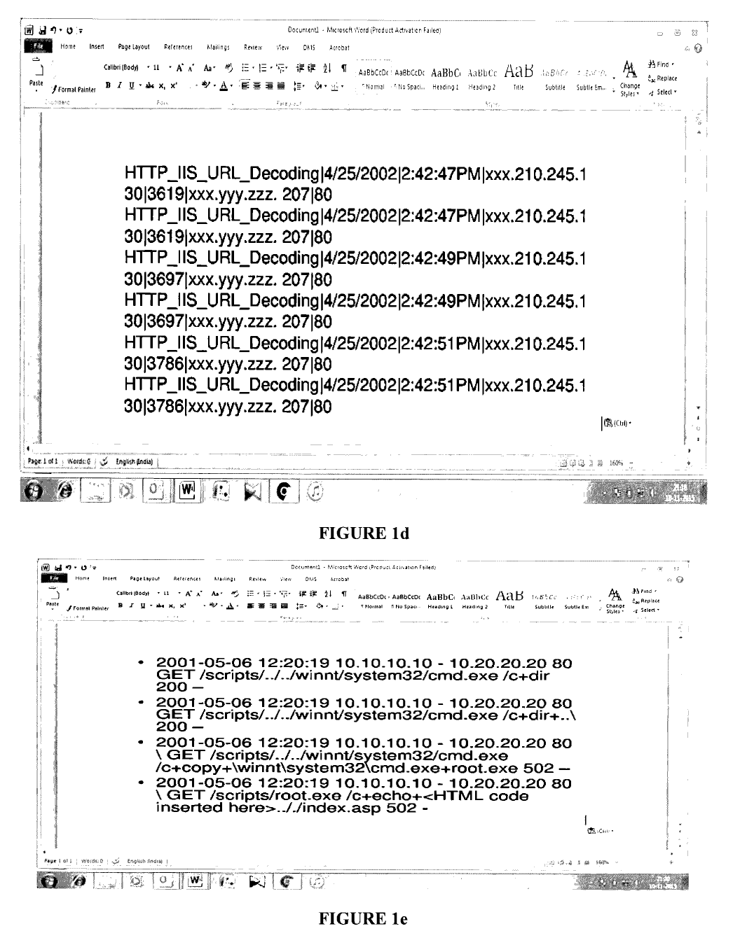

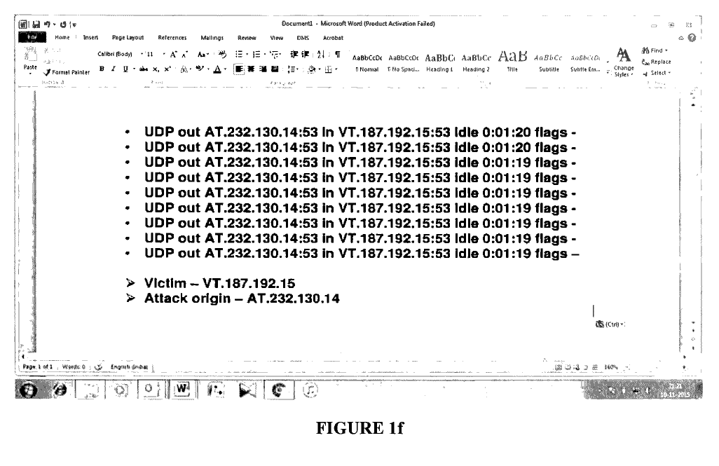

FIG. 1 illustrates an exemplary embodiment of environment for identifying root-cause of issues of software applications during software productions in accordance with some embodiments of the present disclosure.

The environment comprises a root-cause identification system 100, one or more user devices 108a, 108b, . . . , 108n (collectively referred to 108n) and one or more sources 110a, 110b, . . . , 110n (collectively referred to 110). In one implementation, the root-cause identification system 100 may be implemented in a variety of computing systems, such as a laptop computer, a desktop computer, a Personal Computer (PC), a notebook, a smartphone, a tablet, e-book readers (e.g., Kindles and Nooks), a node in a network, a server, a network server, and the like. In one example, the root-cause identification system 100 is configured to identify root-cause of issues of the software applications and/or hardware components during the software productions, in an embodiment, the root-cause identification system 100 functions both in online and offline mode. The components of the root-cause identification system 100 are explained in detail below sections of the description.

In an embodiment, the root-cause identification system 100 is communicatively connected to the one or more user devices 108 and the one or more sources 110 over a network (not shown in FIG. 1).

The one or more user devices 108 are associated to the one or more users involved in the software productions. Particularly, the one or more user devices 108 are used in software production environment for developing the software and/or the software applications. The one or more user devices 108 include, but are not limited to, computing systems, such as a laptop computer, a desktop computer, a Personal Computer (PC), a notebook, a smartphone, a smart watch, a wearable device, a tablet, e-book readers (e.g., Kindles and Nooks). In an embodiment, during the software productions and/or development of the software applications, one or more log files are generated which relate to errors, mistakes or fault of the software application and/or hardware components corresponding to the software productions/development of the software applications. Particularly, the one or more log files provide clues about issues, without limitations, performance issues, application function problems, intrusion and attack attempts etc. during the software productions/the development of the software applications. Examples of the one or more log files associated with the software applications and/or the hardware components are provided in below description. Also, examples of components or sources from where the one or more log files are generated and received are explained in below description. The one or more user devices 108 receives the notification of the one or more log files and/or receives the one or more log files itself. In an embodiment, result of identification of root-cause of issues associated with each log file of the one or more log files are notified and displayed on a display device (not shown in FIG. 1) of each of the one or more user devices 108. In an embodiment, corrective measures received from the root-cause identification system 100 to correct the issues of the one or more log files are displayed on the display device associated to the one or more user devices 108. In an embodiment, the one or more user devices 108 may act as the root-cause identification system 100. In such a case, the one or more user devices 108 can identify the root-cause of the issues of the log files associated with the software applications.

The one or more sources 110 refer to, without limitations, web servers used for software productions, applications run for software productions, systems/devices/units that are used for the software productions, intrusion Detection System (IDS) which detects the log files during the software productions, Intrusion Prevention System (IPS) which prevents the failure of the software production due to the one or more log files or provides the corrective measure to the issues of the one or more log files, firewalls used for the software productions, databases that are accessed or used for software productions and other such sources which can be referred typically for the software productions. The log files further includes, without limitations, File Transfer Protocol (FTP) log files, mail server log files, memory log files, Operating System (OS) log files etc. In such cases, examples of the one or more log files include, but are not limited to, web server log files, event log files, IDS log files, IPS log files, databases log files, application log files, firewalls log files, etc. Each log file of the one or more log files is related to a particular issue which may be associated with web server, applications, events, IDS, IPS, databases, systems, units or devices etc. Further, each log file may or may not affect other systems, units, applications etc. which may overall affects the software productions. Thus, root-cause (i.e. detection of origin of the log files) identification due to generation of the one or more log files is carried out in the present disclosure.

The web server log files may refer to server based logs like more stress on the server, single server access logs, server error logs etc. Example of web server error log is shown in FIG. 1b. Example of web server access log files is shown in FIG. 1c.

The event log files refers to events generated by various systems, applications, devices, units, components, Operating Systems (OSs), web servers, mail servers, FTP servers etc. Example of event log file is give as below in Table 1:

TABLE 1

| Event log files | Event Identification (ID) |
|---|---|
| Local logon attempt failures | 529, 530, 531, 532, 533, 534, and 537 |
| Account Misuse | 530, 531, 532, and 533 |
| Account Lockouts | 539 |
| Domain logon attempt failures | 675, 677 |
| Creation of a user account | 624, 626 |
| Global group membership | 632, 633 |
| modifications | |
| Domain local group membership | 634, 635 |
| modifications | |

The IDS log files refers to logs generated with reference to systems detecting the intrusions. Example of IDS log files is given in FIG. 1d.

The system log files refers to systems/devices/units based logs or faults, or errors during the software productions. Example of the system log files is shown in FIG. 1e.

The firewall log files refer to logs or errors resulting from the firewall accesses. Example of the firewall log files is shown in FIG. 1f.

In an embodiment, the one or more user devices 108 may act as the one or more sources 110 generating the one or more log files.

In the illustrated FIG. 1, the root-cause identification system 300 comprises an I/O interface 102, a central processing unit. (“CPU” or “processor”) 104 having one or more processing units, and a memory 106 in accordance with some embodiments of the present disclosure.

The I/O interface 102 is a medium through which one or more log files associated with one or more software applications are received from the one or more sources 110. The I/O interface 102 provides trend of one or more types of issues to a display unit (not shown in FIG. 1) for a predetermined time interval for user analysis. The I/O interface 102 notifies root-cause of corresponding type of issues associated with the log files of the one or more software applications. The I/O interface 102 provides one or more corrective measures recommended towards each type of issues based on identification of the root-cause of the corresponding type of issues. The I/O interface 102 is coupled with the processor 104. The processor 104 is configured to identify the root-cause of the issues of the one or more software applications based on the corresponding type of issues and corresponding trends of the type of issues.

The processor 104 may comprise at least one data processor for executing program components for processing system-generated log files associated with the one or more software applications. The processor 104 is configured to filter the one or more log files to determine pattern of each log file of the one or more log files. In an embodiment, the processor 104 filters the one or more log files based on predefined filtering rules defining priority and criticality of each log file of the one or more log files. In an embodiment, the pattern of each log file includes, but is not limited to, type of each log file, behavior of each log file, and alerts associated with each log file. The processor 104 sets the priority and the criticality of the filtered one or more log files and the alerts associated with each log file based on the pattern of corresponding log file using predefined pattern rules. The processor 104 determines the one or more types of issues associated with each of the one or more log files based on the pattern of the corresponding one or more log files. In an embodiment, the processor 104 determines the one or more types of issues by performing analysis of the pattern of each log file and correlating the analyzed pattern of each log file with predefined patterns of log files. The processor 104 sets priority and criticality of each of the one or more types of issues using predefined issue rules. The processor 104 estimates the trend of the one or more type of issues by comparing the one or more types of issues with historical data relating to corresponding pattern of log file. In an embodiment, the processor 104 analyzes the trend of the one or more type of issues for a predetermined time interval, for example 10 days, 90 days etc. The processor 104 identifies the root-cause of issues of the one or more software applications based on the one or more types of issues and the trend of the one or more type of issues. In an embodiment, the processor 104 determines the root-cause of issues of the one or more software applications based on predetermined classifications of issues defined by predefined classification rules. In an embodiment, the processor 104 recommends one or more corrective measures towards each type of issues based upon identification of the root-cause of the corresponding type of issues. Various functionalities performed by the processor 104 are achieved using one or more modules that are stored in the memory 106 which are explained in below description.

The memory 106 stores instructions which are executable by the at least one processor 104. In an embodiment, the memory 106 stores log files data, predefined filtering rules, pattern information, predefined pattern rules, predetermined settings, types of issues data, predefined issue rules, trends data, historical data, root-cause data, predefined classification rules and corrective measures data. In an embodiment, the log files data, the predefined filtering rules, pattern information, the predefined pattern rules, the predetermined settings, the types of issues data, the predefined issue rules, the trends data, the historical data, the root-cause data, the predefined classification rules and the corrective measures data are stored as one or more data required for identifying the root-cause of the issues of the one or more software applications for the software productions as described in the following description of the disclosure.

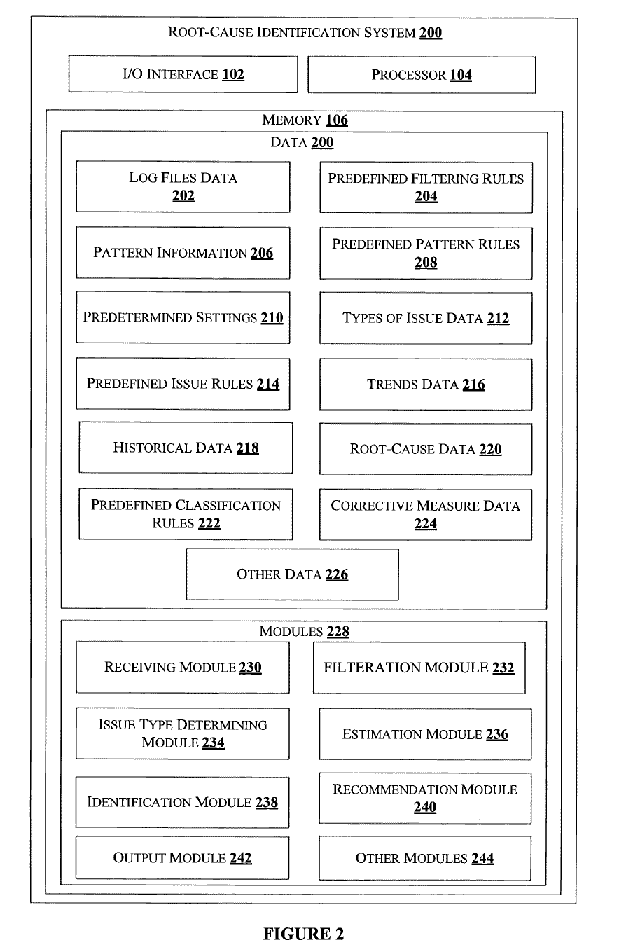

FIG. 2 illustrates a block diagram of the exemplary root-cause identification system 100 with various data and modules for identifying the root-cause of the issues of the one or more software applications in accordance with some embodiments of the present disclosure. In the illustrated FIG. 2, the one or more data 200 and the one or more modules 228 stored in the memory 106 are described herein in detail.

In an embodiment, the one or more data 200 may include, for example, the log files data 202, the predefined filtering rules 204, pattern information 206, the predefined pattern rules 208, the predetermined settings 210, the types of issues data 212, the predefined issue rules 214, the trends data 216, the historical data 218, the root-cause data 220, the predefined classification rules 222, the corrective measures data 224, and other data 226 for identifying the root-cause of the issues of the one or more software applications.

The log files data 202 contains the one or more log files associated with the one or more software applications used for the software productions where the one or more log files are received from the one or more sources. The one or more log files include, but are not limited to, web server log files, event log files, IDS log files, IPS log files, databases log files, application log files etc. firewalls log files, etc.

The predefined filtering rules 204 comprise rules set required for filtering the one or more log files. The predefined filtering rules 204 define priority and criticality of each log file of the one or more log files. In an embodiment, the predefined filtering rules 204 is updated based on changes in the one or more log files, the priority and the criticality of the one or more log files.

The pattern information 206 contains predetermined patterns of each log file such as type of each log file, behavior of each log file and alerts associated with each log file. Further, the pattern information 206 contains warning information of each log file.

The predefined pattern rules 208 contain rule set for analyzing the pattern of each filtered log file. In an embodiment, the predefined pattern rules 208 are used to set priority and criticality of the filtered one or more log files and the alerts associated with each log file corresponding to the filtering based on the pattern of the corresponding log file. In an embodiment, the predefined pattern rules 208 is updated based on changes in the pattern of each filtered log file which in turn changes the priority and the criticality of the filtered one or more log files and the alerts of corresponding log file.

The predetermined settings 210 contains settings or configuration information to set priority and criticality of each filtered log file, the alerts of the corresponding log file, and each of the one or more type of issues of the corresponding log file.

The type of issues data 212 contains the type of issues associated with each filtered log file. In an embodiment, the type of issues associated with each filtered log file is determined based on the pattern of the corresponding log file. For example, if the log file is event log file then the type of issue is determined to be event log issue.

The predefined issue rules 214 contains rule set for setting the priority and the criticality of each of the one or more type of issues. In an embodiment, the predefined issue rules 214 is updated based on changes in the pattern of each filtered log file.

The trend data 216 contains trends of each type of issue associated to the particular pattern of each filtered log file. In an embodiment, the trend data 216 contains predetermined time interval for which the trends of each type of issue is determined.

The historical data 218 contains historical information including, without limitation, type of log file information, behavior of corresponding log file, pattern, alerts and warning associated with the corresponding log file, priority and criticality of the corresponding log file which occurred in the past.

The root-cause data 220 contains information relating to the root-cause of the issue associated with corresponding type of issue of the trend of the type of issue. The root-cause of the issue is stored as root-cause data 220 after being identified from the corresponding trend of the type of issue associated with the filtered log file.

The predefined classification rules 222 contains rule set for classifying the type of issue which in turn is used for identifying the root-cause of the issue of the corresponding log file. In an embodiment, the predefined classification rules 222 contain classification of each issue of each type of issue corresponding to each log file.

The corrective measures data 224 contains such corrective measures recommended for the identified root-cause of the issue of the one or more software applications based on the trend of the corresponding log file and type of issues of the corresponding log file.

The other data 226 may refer to such data which can be referred for identifying the root-cause of the issues of the one or more software applications based on the one or more log files, the type of issues of each log file and the trends of each of type of issue.

In an embodiment, the one or more data 200 in the memory 106 are processed by the one or more modules 228 of the root-cause identification system 100. The one or more modules 228 may be stored within the memory 106 as shown in FIG. 2. In an example, the one or more modules 228, communicatively coupled to the processor 104, may also be present outside the memory 106 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 228 may include, for example, a receiving module 230, a filtration module 232, an issue type determining module 234, an estimation module 236, an identification module 238, a recommendation module 240, and an output module 242. The memory 106 may also comprise other modules 244 to perform various miscellaneous functionalities of the root-cause identification system 100. It will be appreciated that such aforementioned modules may be represented as a single module or a combination of different modules.

The receiving module 230 retrieves the one or more log files from the one or more sources 110. For example, the receiving module 230 receives/retrieves the web server log files, OS log files, firewall log files, application log files, system log files etc. from the one or more sources 110. In an embodiment, the receiving module 230 receives the one or more log files different application performance monitoring systems (not shown).

The filtration module 232 filters the one or more log files received from the one or more sources 110 to determine pattern of each log file of the one or more log files. In an embodiment, the one or more log files is filtered based on the predefined filtering rules defining the priority and the criticality of each log file of the one or more log files. In an embodiment, the pattern of each filtered log file is determined as per predetermined models. The pattern includes, without limitations, the type of each log file, the behavior of each log file, and the alerts associated with each log file. The predetermined models include, without limitations, event log Which is identified by a step header of a log file, web or application log which is identified with “#” tag information of a log file, database log which is identified by notational language and/or Procedural Language (PL) or Structured Query Language (SQL), and service components log which are identified through Web System Description Language (WSDL)/discovery etc. In an embodiment, the priority and the criticality are set for the filtered log files and the alerts associated with the filtered log files using the predefined pattern rules. In an embodiment, the filtered log files are addressed for identifying the root-cause of the one or more software application of corresponding filtered log files based on the alerts of the corresponding log files, the priority and criticality of the corresponding log files.

For example, considering, series of alerts from event log by an event-ID: 1000, and also considering warnings with event-ID: 83, then the event log is prioritized and addressed for filtration and pattern determination. From the pattern of each filtered log file, area to which the filtered log file is related is determined.

The issue type determining module 234 determines the one or more types of issues associated with each of the one or more log files based on the pattern of corresponding one or more log files. In an embodiment, issue type determining module 234 comprises a quotient validator (not shown) which determines total headers of each filtered log file and area to which the filtered log file is related to from the pattern of each filtered log file. From the total headers of each filtered log file and area associated to the filtered log file is determined. In an embodiment, the one or more types of issues associated with each of the one or more log files is determined by performing analyzing the pattern of each log file and correlating the analyzed pattern of each log file with the predefined patterns of log files stored as pattern information 206. The different types of issues from the pattern of each filtered log file are determined as explained in following examples. For example, consider an event log containing the pattern of the event log as 2 digits or 3 digits or 4 digits or single digit. In such a case, the types of issues of such event log are determined to be either warning or error Or showstopper. For example, consider a webserver issue, then quotient validator verifies whether series contained in the webserver issue is 3 series or 4 series or 5 series or 2 series of format. If the series starts with 4, then quotient validator classifies the webserver issue as application level issue. If the series starts with 5, then the quotient validator classifies the webserver issue as a webserver issue only. Consider an OS issue, then the quotient validator verifies whether the OS issues is related to processor/memory/disk/etc. If the issue is related to processor then the quotient validator starts collecting log files for the processor for determined counter i.e. predetermined time interval, for example 1 day. If the issue is related to database, then the quotient validator monitors both the OS log files and database log files, in such a case, if a query is working for long time, then the quotient validator monitors the database locks and also the quotient validator monitors the SQL joins and query execution plan. In such a case, the quotient validator considers the header or area count. In an embodiment, the priority and the criticality of each of the one or more types of issues are set using the predefined issue rules.

The estimation module 236 estimates the trend of the one or more types of issues. In one implementation, the trend of the one or more types of issues is estimated by comparing the one or more types of issues with the historical data 218 relating to corresponding pattern of log file where the history events are compared with the existing issue to forecast the trend. In an embodiment, forecasting is major factor for predicting the future trend. In an embodiment, the trend of the one or more types of issues is analyzed for a predetermined time interval, for example for 90 days. The log files are collected based on the result obtained by the quotient validator and the trends of the one or more types of issues as given below in equation (1):

C=Eq˜Tr (1)

Where Eq is the quotient validator, Tr is the trend and C is collected log files. In an embodiment, the quotient validator and the trend of the one or more types of issues are directly relational, where the quotient validator keeps on verifying the trend was for past days and compares with new set of log files. If any new log files or error been identified which is not part of the trend, then below formula is affected as:

Lt_{Tr→90}=Eq−Cnc (2)

where Cnc−past log files and Lt is new log file.

For e.g. if a user chosen value as 90 days, then trend is collected for 90 days for all the areas. For example, consider there is a DB issue. In such a situation, every query retrieves the data count more than 1000. Hence, in such a case, the query performance is degraded when such query received is more than 10 times. Then, the trend is predicted as below:

Bn=count of days*times per day issue average (3)

Where Bn represents the vulnerability ratio and the count of days represents the total number of days. Therefore, the average value of next proportional 90 days is 90*10 i.e. for 900 times the issue emerges.

The identification module 238 identifies the root-cause of issues of the one or more software applications based on the one or more types of issues and the trend of the one or more type of issues. In an embodiment, the root-cause of issues of the one or more software applications is determined based on the predetermined classifications of issues defined by the predefined classification rules. For example, considering a scenario there were long response times, and page is not able to retrieve values of a data grid. Then the log files are determined to he associated to hardware/webserver/application server/DB server. Then, the respective counters and also the parallel area, like DB locks and connection time out from OS are monitored in parallel by monitoring the long running queries. The query execution plan also monitored to analyze the total complexity of the query. The hardware and the log files are compared with each other and then based on the comparison the issue is determined to be DB issue. Based on the determination, the queries which are making the delays are reported to the one or more user devices 108.

The recommendation module 240 recommends the one or more corrective measures towards each type of issues based upon identification of the root-cause of the corresponding type of issues. For example, consider the issue is in a virtual machine where a Random Access Memory (RAM) is been configured as 10 GB. However, the RAM capacity is 30 GB. In such a case, increasing of the RAM capacity is recommended and the RAM capacity is increased to fix the issue.

The output module 242 provides the result of the identification of the root-cause of the issue along with recommendation to the one or more user devices 108.

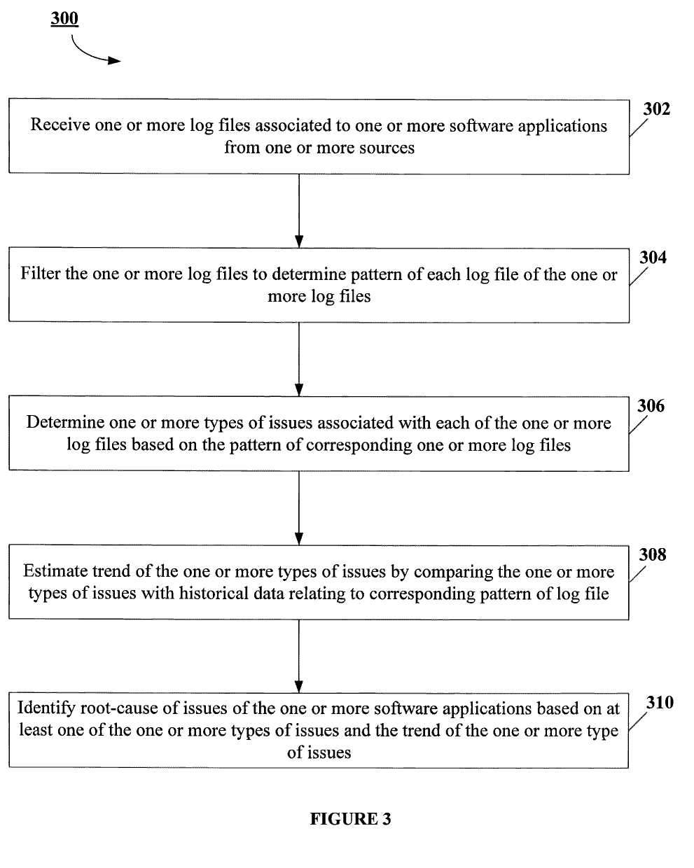

FIG. 3 shows a flowchart illustrating a method 300 for identifying the root-cause of the issues of the one or more software applications in accordance with some embodiments of the present disclosure.

As illustrated in FIG. 3, the method comprises one or more blocks for identifying the root-cause of the issues of the one or more software applications. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method 300 can be implemented in any suitable hardware, software, firmware, or combination thereof.

At block 302, the one or more log files associated to the one or more software applications are received from the one or more sources 110.

At block 304, the one or more log files are filtered to determine the pattern of each log file of the one or more log files. In an embodiment, the one or more log files is filtered based on predefined filtering rules defining the priority and the criticality of each log file of the one or more log files. In an embodiment, the pattern of each log file comprises the type of each log file, the behavior of each log file, and the alerts associated with each log file. In an embodiment, the priority and the criticality of the filtered one or more log files, and the alerts associated with each log file corresponding to the filtering are set based on the pattern of corresponding log file using predefined pattern rules.

At block 306, the one or more types of issues associated with each of the one or more log files are determined based on the pattern of corresponding one or more log files. In an embodiment, the one or more types of issues associated with each of the one or more log files is determined by performing analyzing the pattern of each log file and correlating the analyzed pattern of each log file with predefined patterns of log files. In an embodiment, the priority and the criticality of each of the one or more types of issues are set using the predefined issue rules.

At block 308, the trend of the one or more types of issues is estimated by comparing the one or more types of issues with the historical data 218 relating to corresponding pattern of log file. In an embodiment, the trend of the one or more types of issues is analyzed for the predetermined time interval.

At block 310, the root-cause of issues of the one or more software applications is identified based on the one or more types of issues and/or the trend of the one or more types of issues. In an embodiment, the root-cause of issues of the one or more software applications is determined based on the predetermined classifications of issues defined by the predefined classification rules. In an embodiment, the one or more corrective measures towards each type of issues is recommended based upon the identification of the root-cause of the corresponding type of issues.

Computer System

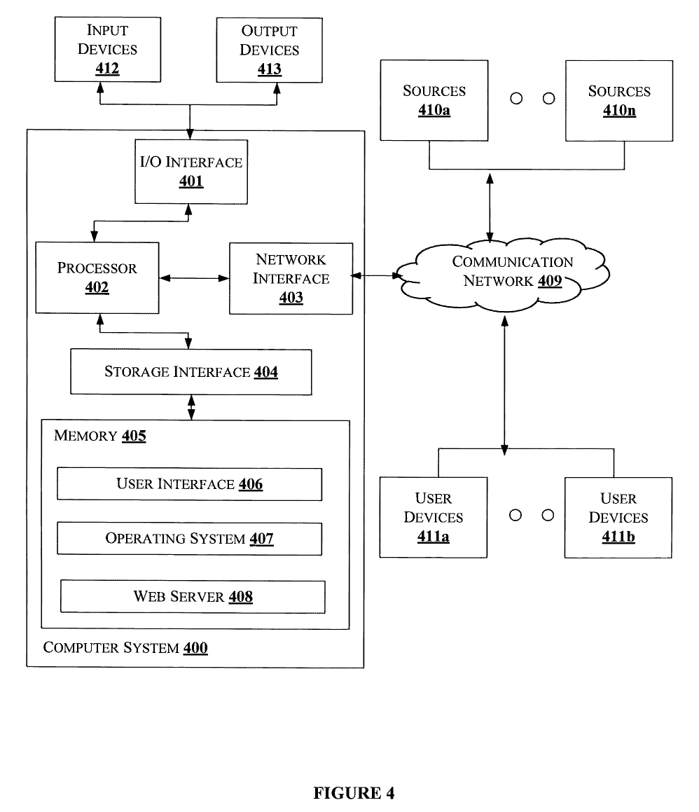

FIG. 4 illustrates a block diagram of an exemplary computer system 400 for implementing embodiments consistent with the present disclosure. In an embodiment, the computer system 400 is used to implement the root-cause identification system 100. The computer system 400 may comprise a central processing unit (“CPU” or “processor”) 402. The processor 402 may comprise at least one data processor for executing program components for executing system-generated log files of the one or more software applications. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WIMax, or the like), etc.

Using the I/O interface 401, the computer system 400 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 is connected to the one or more user devices 411a, . . . , 411n, and the one or more sources 410a . . . 410n through a communication network 409. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with the one or more user devices 911a, . . . , 911n, and the one or more servers 910a, . . . , 910n. The network interface 403 may employ connection protocols include, but not limited to, direct connect, Ethernet (e.g., twisted pair 10/100/1000 Base T), transmission control protocol/Internet protocol (TCP/IP), token ring, IEEE 802.11a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 1005 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (BATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web server 408 etc. in some embodiments, computer system 400 may store user/application data 406, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), Free SSD, NetBSD, OpenBSD, etc.), Linux distributions (e.g., Red Hat, Ubuntu, Kubuntu, etc.), IBM OS/2, Microsoft. Windows (XP, Vista/7/8, etc.), Apple iOS, Google Android, Blackberry OS, or the like.

In some embodiments, the computer system 400 may implement a web browser 407 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla. Thunderbird, etc.

Furthermore, one or more computer-readable storage media may be utilized implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure automates the identification of root-cause of issues of the software applications without human intervention.

Embodiments of the present disclosure provide decision making and log analysis without human support.

Embodiments of the present disclosure identify the root-cause with reference to the history data and also provide future prediction on the quality of issue with respect to the performance of software production

The described operations may be implemented as a method, system or article of manufacture using standard programming and/or engineering techniques to produce software, firmware, hardware, or any combination thereof. The described operations may be implemented as code Maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e,g., hard disk drives, floppy disks, tape, etc.), optical storage (CD-ROMs, DVDs, optical disks, etc.), volatile and non-volatile memory devices (e.g., EEPROMs, ROMs, PROMs, RAMS, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will, be readily apparent that a single device/article may be used in place of the more than one device or article or a different number of devices/articles may be used instead of the shown number of devices or programs. The functionality and/or the features of a device may be alternatively embodied by one or more other devices which arc not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Root-Cause Identification System |
| 102 | I/O Interface |
| 104 | Processor |
| 106 | Memory |
| 108a, . . . , 108n | User Devices |
| 110a, . . . , 110n | Sources |
| 200 | Data |
| 202 | Log Files Data |
| 204 | Predefined Filtering Rules |
| 206 | Pattern Information |
| 208 | Predefined Pattern Rules |
| 210 | Predetermined Settings |
| 212 | Types of Issue Data |
| 214 | Predefined Issue Rules |
| 216 | Trends Data |
| 218 | Historical Data |
| 220 | Root-Cause Data |
| 222 | Predefined Classification Rules |
| 224 | Corrective Measure Data |
| 226 | Other Data |
| 228 | Modules |
| 230 | Receiving Module |
| 232 | Filtration Module |
| 234 | Issue Type Determining Module |
| 236 | Estimation Module |
| 238 | Identification Module |
| 240 | Recommendation Module |
| 242 | Output Module |
| 244 | Other Modules |
| 400 | Computer System |
| 401 | I/O Interface |
| 402 | Processor |
| 403 | Network Interface |
| 404 | Storage Interface |
| 405 | Memory |
| 406 | User Interface |
| 407 | Operating System |
| 408 | Web Server |
| 409 | Communication Network |
| 410a, . . . , 410n | Sources |
| 411a, . . . , 411n | User Devices |
| 412 | Input Devices |
| 413 | Output Devices |

We claim:

1. A method for identifying root-cause of issues of software applications, the method comprising:
receiving, by a root-cause identification system, one or more log files associated to one or more software applications from one or more sources;
filtering, by the root-cause identification system, the one or more log tiles to determine pattern of each log file of the one or more log files;
determining, by the root-cause identification system, one or more types of issues associated with each of the one or more log files based on the pattern of corresponding one or more log files;
estimating, by the root-cause identification system, trend of the one or more types of issues by comparing the one or more types of issues with historical data relating to corresponding pattern of log file; and
identifying, by the root-cause identification system, root-cause of issues of the one or more software applications based on at least one of the one or more types of issues and the trend of the one or more type of issues.

2. The method as claimed in claim 1, wherein filtering the one or more log files is performed based on predefined filtering rules defining at least one of priority and criticality of each log file of the one or more log tiles.

3. The method as claimed in claim 1, wherein the pattern of each log file comprises at least one of type of each log file, behaviour of each log file, and alerts associated with each log file.

4. The method as claimed in claim 3 further comprising setting by the root-cause identification system, at least one of priority and criticality of at least one of the filtered one or more log files, and the alerts associated with each log file corresponding to the filtering based on the pattern of corresponding log file using predefined pattern rules.

5. The method as claimed in claim 1, wherein the one or more types of issues associated with each of the one or more log files is determined by performing analysing the pattern of each log file and correlating the analysed pattern of each log file with predefined patterns of log files.

6. The method as claimed in claim 5 further comprising setting by the root-cause identification system, priority and criticality of each of the one or more types of issues using predefined issue rules.

7. The method as claimed in claim 1, wherein the trend of the one or more types of issues is analysed for a predetermined time interval.

8. The method as claimed in claim 1, wherein the root-cause of issues of the one or more software applications is determined based on predetermined classifications of issues defined by predefined classification rules.

9. The method as claimed in claim 1, further comprising recommending by the root-cause identification system, one or more corrective measures towards each type of issues based upon identification of the root-cause of the corresponding type of issues.

10. A root-cause identification system for identifying root-cause of issues of software applications, comprising:
a processor;
a memory communicatively coupled to the processor, wherein the memory stores processor-executable instructions, which, on execution, cause the processor to:
receive one or more log files associated to one or more software applications from one or more sources;
filter the one or more log files to determine pattern of each log file of the one or more log files;
determine one or more types of issues associated with each of the one or more log files based on the pattern of corresponding one or more log files;
estimate trend of the one or more types of issues by comparing the one or more types of issues with historical data relating to corresponding pattern of log file; and
identify root-cause of issues of the one or more software applications based on at least one of the one or more types of issues and the trend of the one or more type of issues.

11. The root-cause identification system as claimed in claim 10, wherein the one or more log files is filtered based on predefined filtering rules defining at least one of priority and criticality of each log file of the one or more log files.

12. The root-cause identification system as claimed in claim 10, wherein the pattern of each log file comprises at least one of type of each log file, behaviour of each log file, and alerts associated with each log file.

13. The root-cause identification system as claimed in claim 12, wherein the processor is further configured to set at least one of priority and criticality of at least one of the filtered one or more log files, and the alerts associated with each log file corresponding to the filtering based on the pattern of corresponding log file using predefined pattern rules.

14. The root-cause identification system as claimed in claim 10, wherein the one or more types of issues associated with each of the one or more log files is determined by performing analysing the pattern of each log file and correlating the analysed pattern of each log file with predefined patterns of log files.

15. The root-cause identification system as claimed in claim 14, wherein the processor is further configured to set priority and criticality of each of the one or more types of issues using predefined issue rules.

16. The root-cause identification system as claimed in claim 10, wherein the trend of the one or more types of issues is analysed for a predetermined time interval.

17. The root-cause identification system as claimed in claim 10, wherein the root-cause of issues of the one or more software applications is determined based on predetermined classifications of issues defined by predefined classification rules.

18. The root-cause identification system as claimed in claim 10, wherein the processor is further configured to recommend one or more corrective measures towards each type of issues based upon identification of the root-cause of the corresponding type of issues.

19. A non-transitory computer readable medium including instructions stored thereon that when processed by a processor cause a root-cause identification system for identifying root-cause of issues of software applications to perform acts of:
receiving one or more log files associated to one or more software applications from one or more sources;
filtering the one or more log files to determine pattern of each log file of the one or more log files;
determining one or more types of issues associated with each of the one or more log files based on the pattern of corresponding one or more log files;
estimating trend of the one or more types of issues by comparing the one or more types of issues with historical data relating to corresponding pattern of log file; and
identifying root-cause of issues of the one or more software applications based on at least one of the one or more types of issues and the trend of the one or more type of issues.
